(19) United States
(12) Patent Application Publication
(10) Pub. No.: US 2016/0121422 A1
(43) Pub. Date: May 5, 2016

(54) WELDING METHOD FOR COPPER AND STEEL AND APPLICATION THEREOF

(71) Applicant: Zhuji Sibeida Machinery Co., Ltd, Zhuji City (CN)

(72) Inventor: Zhuangwei SI, Zhejiang Province (CN)

(21) Appl. No.: 14/815,465

(22) Filed: Jul. 31, 2015

(30) Foreign Application Priority Data
Oct. 30, 2014 (CN) 201410603279.2
Dec. 12, 2014 (CN) 201410766123.6

(51) Int. Cl. B23K 9/173; B23K 35/30; B23K 9/23; B23K 35/02

(52) U.S. Cl. CPC B23K 9/173; B23K 35/0261; B23K 35/3033; B23K 35/302; B23K 35/3006; B23K 9/232; B23K 2203/22

(57) ABSTRACT

A welding method for copper and steel and application thereof is described herein. The welding method includes the following steps: butt connecting or sleeve connecting an end to be welded of a copper material with an end to be welded of a steel material; and welding and connecting the end to be welded of the copper material and the end to be welded of the steel material by a heating part of a heat supply device under the protection of a shielding gas, wherein the top end of the heating part is shifted towards the copper material, and the end to be welded of the copper material and the end to be welded of the steel material are simultaneously molten and further fuse mutually.

### BACKGROUND OF THE INVENTION

1. Field of the Invention

This invention relates to the field of welding of pipes and materials and, more particularly, relates to a welding method for copper and steel and application thereof.

2. Description of the Related Art

With development of society, national energy-saving and consumption-reducing policies are promoted continuously. In every industry, resources are continuously saved, and energy consumption is continuously reduced. In the refrigeration industry, a precious metal with good plasticity and strength, namely “copper”, has always been used as a main raw material for production and processing. In the development course of the industry in these years, many scientists performed research work on substitution of various materials, and it was well known that aluminum was used for replacing copper. Although aluminum has good plasticity, the strength and the weight thereof cannot meet the general requirements in the field of refrigeration or air conditioners, and the aluminum metal can only be used for replacing copper in a small part. Thus, an extremely urgent event which is conductive to the industry and the national development is to find a material which has not only a certain strength, but also plasticity processing performance.

Steel is a material which can meet the requirements in the refrigeration industry in the aspects of strength and mass. The welding of copper and steel belongs to the welding of two different metals. As for the welding of the two different metals, due to different melting points, different heat conduction rates, and different metallurgical structures in a liquid state, it is very difficult to realize solderless welding directly. Thus, generally speaking, as for welding of the different metals, a solder is added for welding. Particularly, the solder with a melting point lower than that of a base material is commonly added for welding, but the way of adding the solder is high in cost and has the risk that the welding material is re-molten at a first welding spot during secondary welding, so that the welding of the different metals has great limitations in actual welding production practices.

In Chinese patent applications “201310438861.3” and “201310695224.4”, it is disclosed that the heat distribution relation of S pipe sections made in different metal materials during welding is as follows: more heat is distributed to the metal with high melting point, and less heat is distributed to the metal with low melting point. It can be known from the description that in the welding process of copper and steel, as the melting point of the steel material is higher than that of the copper material, a heating piece (such as a tungsten needle) for providing heat in the welding process should be shifted to the end of the steel material.

In actual use, if the welding of the copper material and the steel material is strictly performed according to the methods provided in the above two patent applications, the situation that the copper material cannot be molten smoothly for ever will appear. The reason causing such situation is that: although the melting point of the steel material is higher than that of the copper material, the heat conduction rate of the copper material is 6 times higher than that of steel (the heat conduction rate λ of steel is 40-60 W/(K·m), and the heat conduction rate λ of copper is 380 W/(K·m)). The copper material has high heat conduction speed and low heat distribution, and of course cannot realize synchronous melting with the steel material. Actually, even the heating piece is arranged right in the middle of a weld seam of the two metals, the two metals cannot be molten synchronously.

### BRIEF SUMMARY OF THE INVENTION

In order to solve the problem that a copper material cannot be molten smoothly when two different metals, namely the copper material and a steel material, are welded to connect each other in the prior art, this invention provides a welding method for copper and steel and application thereof.

In order to achieve the above objective, the invention provides a welding method for copper and steel, comprising the following steps: butt connecting or sleeve connecting an end to be welded of a copper material with an end to be welded of a steel material; and welding and connecting the end to be welded of the copper material and the end to be welded of the steel material by a heating part of a heat supply device under the protection of a shielding gas, wherein a top end of the heating part is shifted towards the copper material, and the end to be welded of the copper material and the end to be welded of the steel material are simultaneously molten and further fuse mutually.

According to one embodiment of the invention, the top end of the heating part is shifted towards the copper material, a shift distance may be 0.1 mm-1.5 mm, when the end to be welded of the copper material and the end to be welded of the steel material are butt connected to form a butt connecting surface, the shift distance is the distance from the top end of the heating part to the butt connecting surface, and when the end to be welded of the copper material and the end to be welded of the steel material are sleeve connected, the shift distance is the distance from the top end of the heating part to an end surface of the end to be welded of the material arranged at the outside by sleeve connection.

According to one embodiment of the invention, the top end of the heating part is shifted towards the copper material, and the shift distance may be 0.2 mm-0.3 mm.

According to one embodiment of the invention, the end to be welded of the copper material and the end to be welded of the steel material may be welded and connected by the heating part of the heat supply device under the protection of an inert gas, and the end to be welded of the copper material and the end to be welded of the steel material may be simultaneously molten and further fuse mutually to form a weld seam.

According to one embodiment of the invention, the heating part of the power supply device may point at a welding spot, and an included angle between the central axis of the heating part and a tangent plane where the welding spot is located may be 5 degrees-175 degrees.

According to one embodiment of the invention, in the welding process, a gas shielding device for providing a shielding gas may be disposed at the place where the copper material and the steel material are butt connected or sleeve connected.

According to one embodiment of the invention, a welding material may be added during welding and connecting of the end to be welded of the copper material and the end to be welded of the steel material, the end to be welded of the copper material and the end to be welded of the steel material may be simultaneously molten and further fuse mutually to form a liquid molten pool, and the welding material may be molten in the liquid molten pool to form a weld seam.

According to one embodiment of the invention, the welding material may be selected from the group consisting of an iron-based welding wire, a nickel-based welding wire, a copper-based welding wire, and a silver-based welding wire.

According to one embodiment of the invention, before the formation of the liquid molten pool, the welding material may be preheated at a distance of 0.5 mm-50 mm from the welding spot, and after the formation of the liquid molten pool, the welding material after being preheated may gradually approach the liquid molten pool and may be molten by the liquid molten pool.

According to one embodiment of the invention, the end to be welded of the copper material may be welded and connected with the end to be welded of the steel material by the welding technique selected from the group consisting of gas tungsten arc welding, argon arc welding, plasma welding, quasi-plasma welding, and laser welding.

According to one embodiment of the invention, the steel material may be carbon steel or stainless steel.

The welding method is applied to welding of a housing of a liquid storage device for a compressor, a housing of a silencer for an air conditioner, a housing of a gas-liquid separator for a central air conditioner, a housing of an oil-gas separator, an exhaust pipe for a refrigeration compressor, a gas suction inner pipe for the refrigeration compressor, a gas suction outer pipe for the refrigeration compressor, a gas inlet pipe of the liquid storage device, a gas outlet pipe of the liquid storage device, a main valve body and a main valve seat of an electromagnetic four-way reversing valve for the air conditioner, a piping on the electromagnetic four-way reversing valve for the air conditioner, the piping of the air conditioner, a connecting pipe of the air conditioner, a reversing valve pipe of the air conditioner, or an expansion valve pipe of the air conditioner.

In conclusion, compared with the prior art, the welding method for copper and steel provided by the invention has the following advantages.

In the welding process, considering the situation that the heat conduction rate of the copper material is much higher than that of the steel material, that is the heat dissipation of the copper material is faster than that of the steel material, by setting the position of the heating part for providing heat for welding, the top end of the heating part is shifted to the direction where the copper material is. Thus, the heat distributed to the end to be welded of the copper material is more than the heat distributed to the end to be welded of the steel material, and the two materials achieve a synchronous melting state and further fuse mutually boundlessly to form a weld seam without leakages and cracks.

In addition, the liquid molten pool is used for melting the welding material and then forming the weld seam, thereby avoiding the problem of incomplete fusion of a welding wire caused by unstable arc voltage due to the existence of the welding material in an arc striking process of a tungsten needle. Meanwhile, the liquid molten pool is used for melting the welding material, so that no spattering exists in the welding process, a workpiece after welding does not need to be cleared up, the welding penetration depth after welding meets the requirements, and the weld seam is plump and has relatively large surface tension. In order to avoid the production of gas holes in the weld seam in the welding process, the heating part is protected by the shielding gas, and a gas shielding device is further added at a welded position, thereby effectively isolating air or other gas and avoiding the production of welding gas holes. Further, the welding method for copper and steel provided by the invention can realize all-position welding, and the excellent welding effect can be obtained even in the situations of vertical-down welding, vertical-up welding and overhead welding.

These and other features, aspects, and advantages of the present invention will become better understood with regard to the following description, appended claims, and accompanying drawings.

### BRIEF DESCRIPTION OF THE DRAWINGS

FIG. 1A is a production principle diagram when a copper material and a steel material are butt connected according to one embodiment of this invention;

FIG. 1B is a production principle diagram when a copper material and a steel material are butt connected and a welding material is added according to one embodiment of the invention;

FIG. 2A is a production principle diagram when a copper material and a steel material are sleeve connected according to one embodiment of the invention;

FIG. 2B is a production principle diagram when a copper material and a steel material are sleeve connected and a welding material is added according to one embodiment of the invention;

FIG. 3A and FIG. 3B are production principle diagrams showing a welding method for copper and steel in the first embodiment of the invention is applied to welding of a gas inlet pipe and a gas outlet pipe of a liquid storage device for a compressor, respectively;

FIG. 4A and FIG. 4B are production principle diagrams showing a welding method for copper and steel in the second embodiment of the invention is applied to welding of a gas inlet pipe and a gas outlet pipe of a gas-liquid separator for a central air conditioner, respectively;

FIG. 5A, FIG. 5B, and FIG. 5C are production principle diagrams showing a welding method for copper and steel in the third embodiment of the invention is applied to welding of an exhaust pipe, a gas suction outer pipe, and a gas suction inner pipe of a refrigeration compressor, respectively;

FIG. 6A and FIG. 6B are production principle diagrams showing a welding method for copper and steel in the fourth embodiment of the invention is applied to welding of a C pipe (S pipe or E pipe) and a D pipe in an electromagnetic four-way reversing valve for an air conditioner, respectively; and

FIG. 7 is a production principle diagram showing a welding method for copper and steel in the fifth embodiment of the invention is applied to welding of a piping of a stop valve.

### DETAILED DESCRIPTION OF THE INVENTION

The inventor finds that when copper and steel materials are welded to connect, due to different heat conductivities and electric conductivities of the two materials, simultaneous melting of two metals is very difficult to realize. Further, when a traditional welding method is adopted for welding, heat conducted by arc striking of a tungsten needle has significant fluctuations during melting of a welding material, thereby causing great impact on welding quality. Electric arc produced by the tungsten needle is simultaneously led onto the ends to be welded of the copper material and the steel material, as well as the welding material, thereby producing the problem of unstable arc voltage.

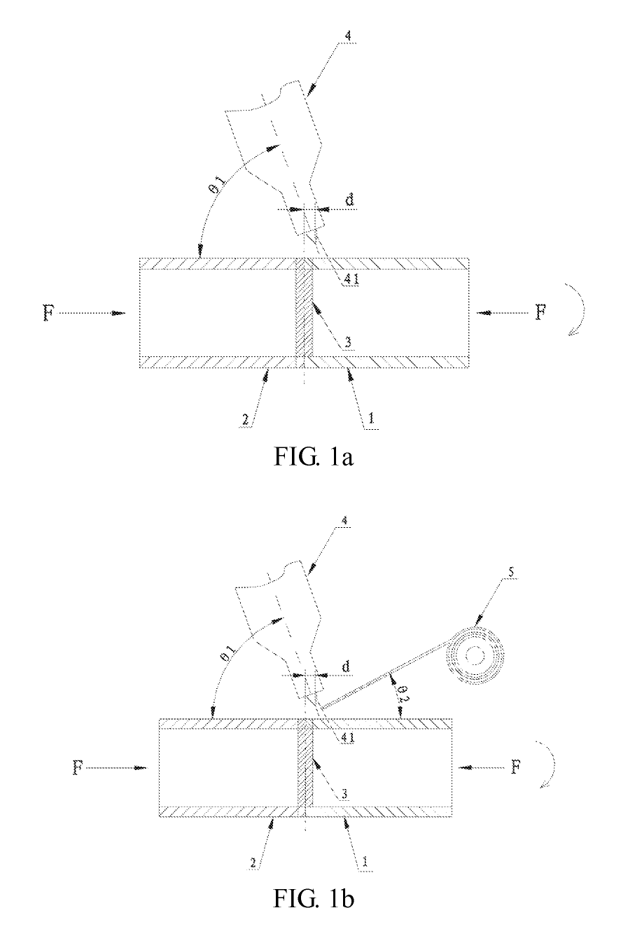

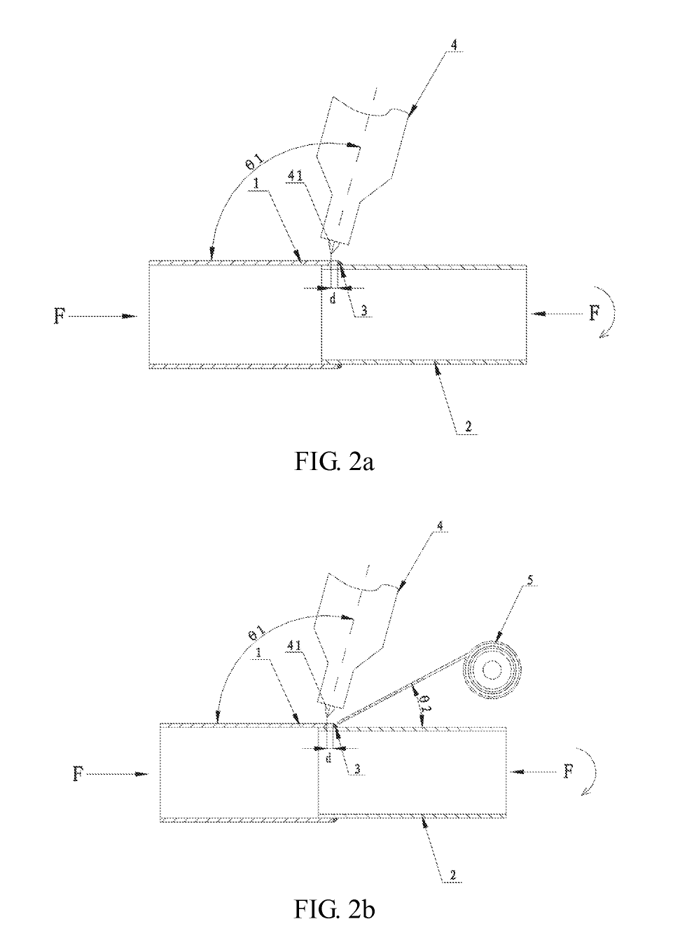

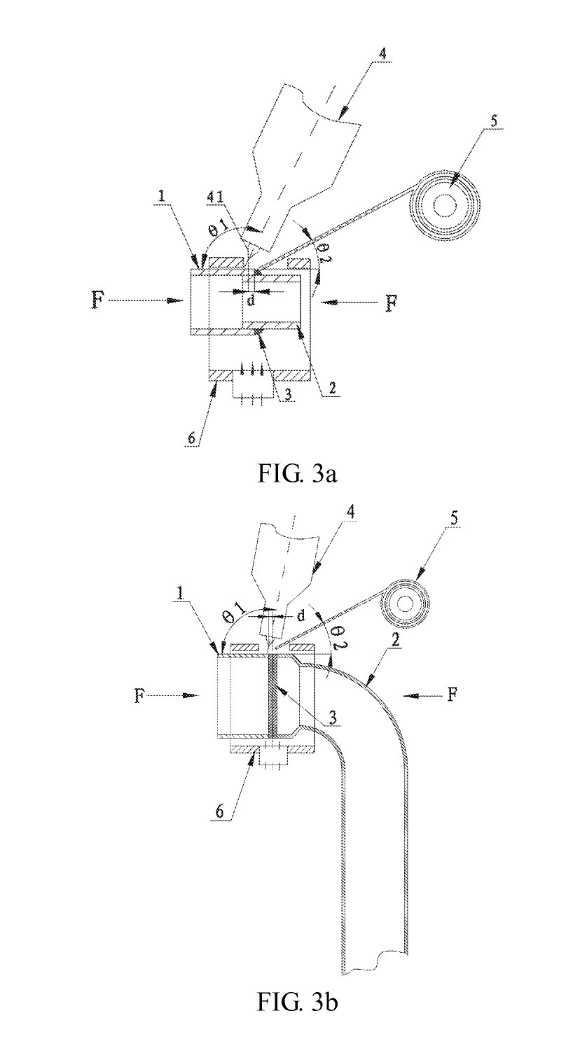

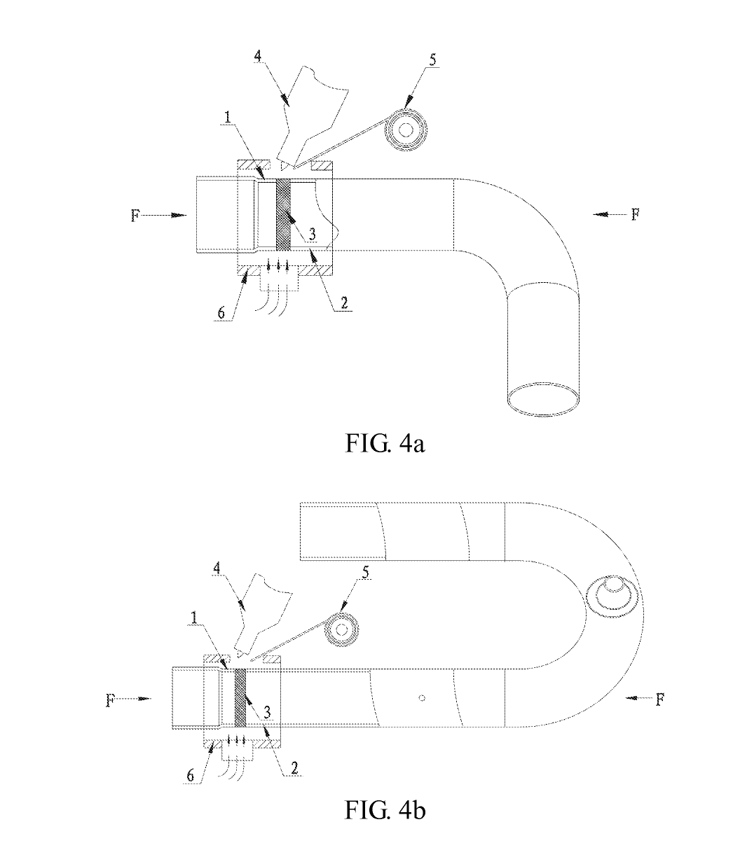

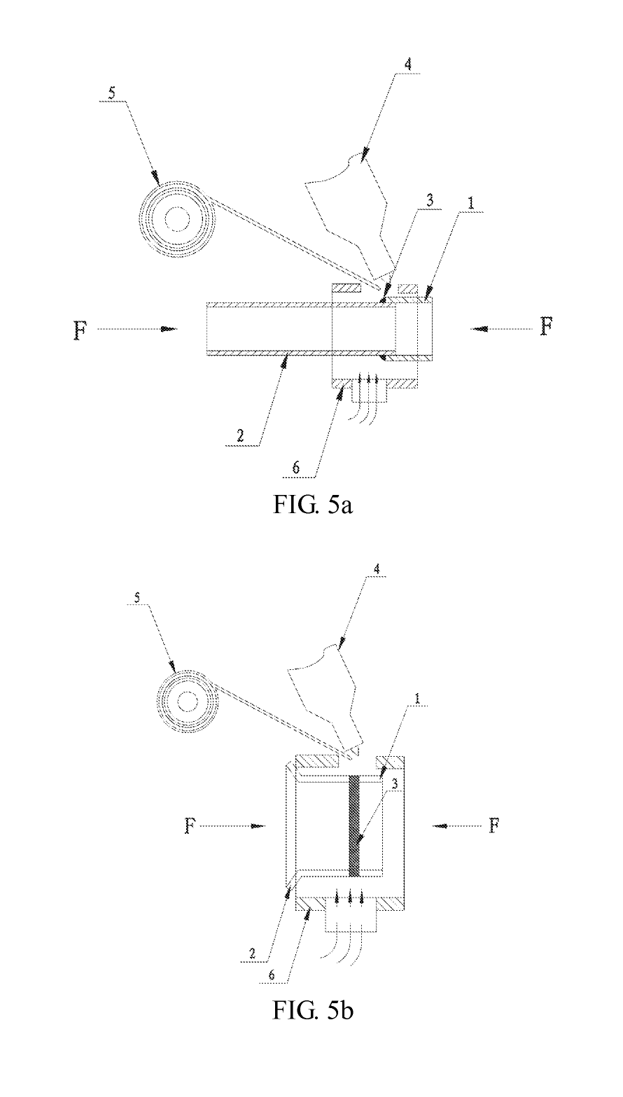

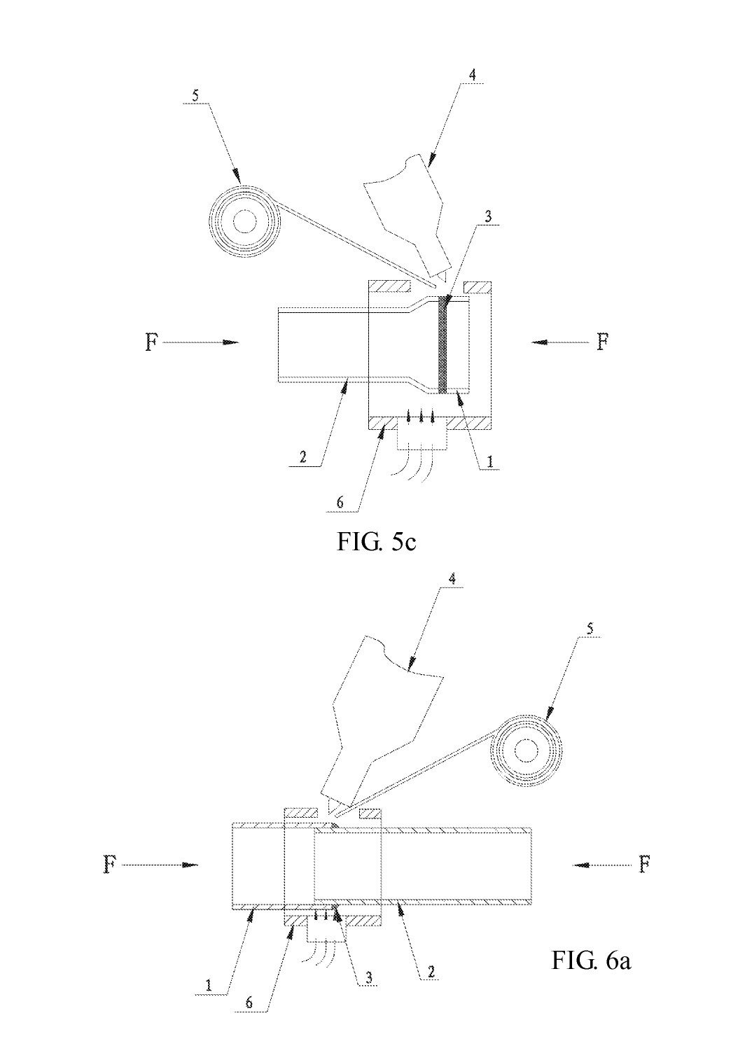

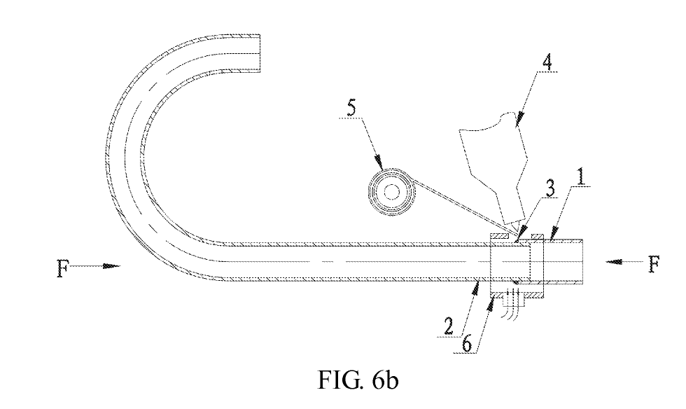

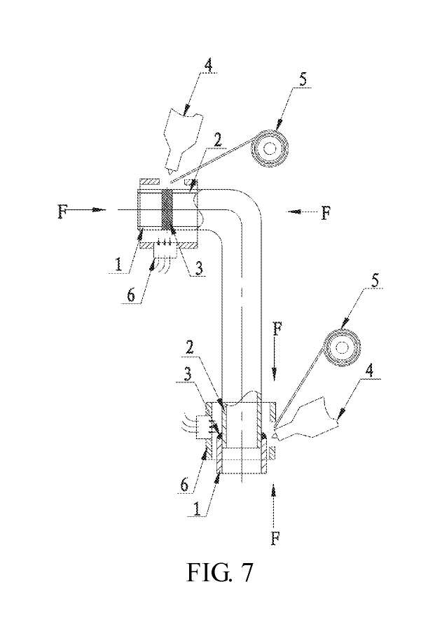

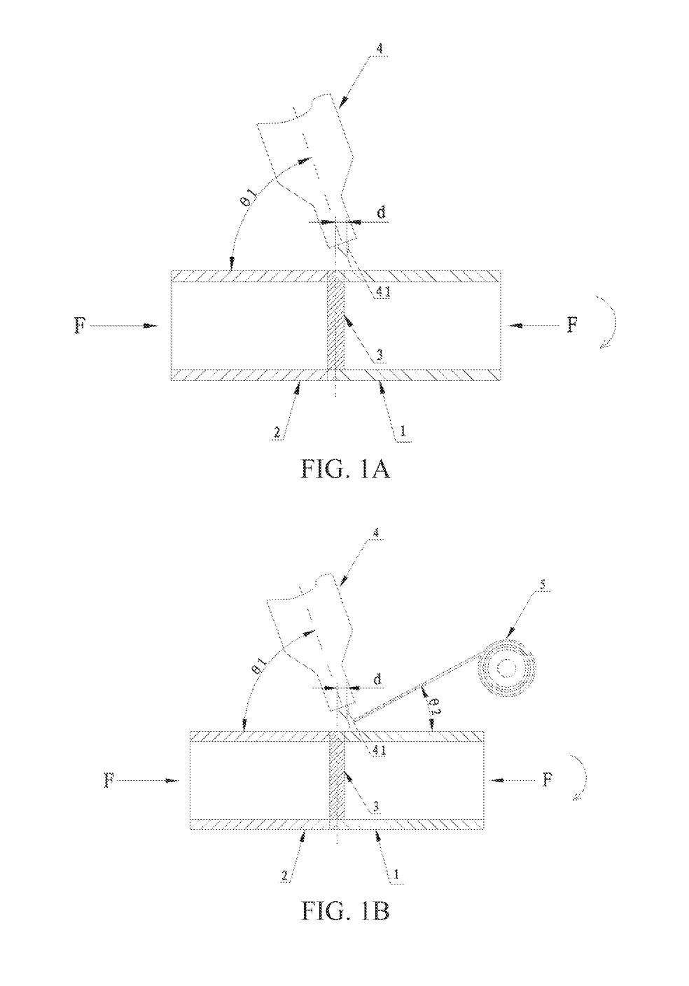

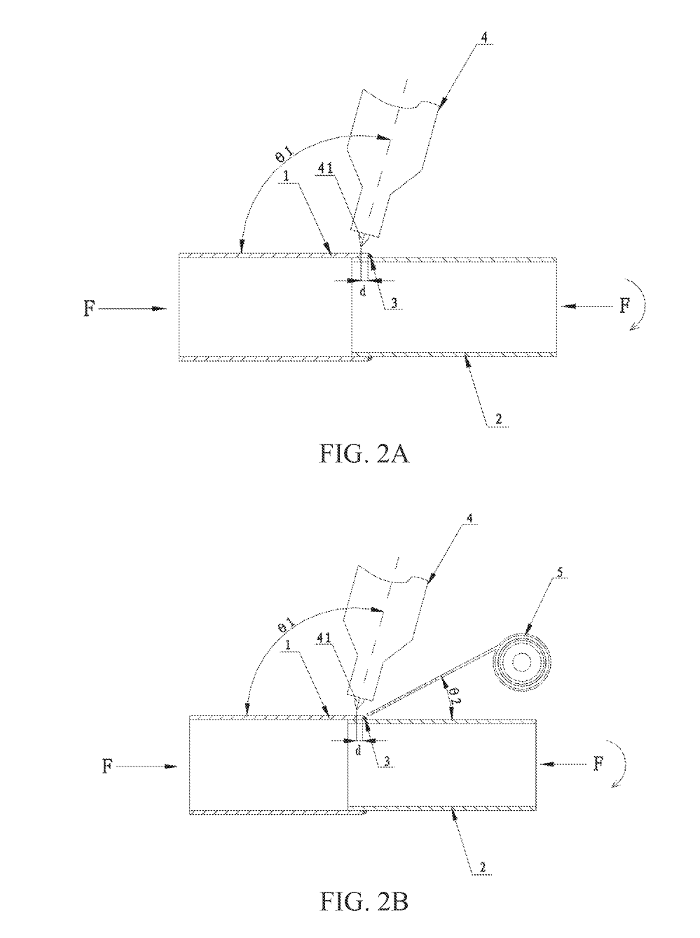

Thus, embodiments of this invention provide a welding method for copper and steel and application thereof. When in welding, by arranging the shift distance of a top end of a heating part, the two metals, namely copper and steel, are simultaneously molten and further fuse mutually to form a liquid molten pool, thereby solving the problem in the existing welding of dissimilar metals. The specific production principle diagrams are as shown in FIG. 1A, FIG. 1B, FIG. 2A, and FIG. 2B. In FIG. 1A and FIG. 1B, the end to be welded of the copper material 1 and the end to be welded of the steel material 2 are butt connected and then are welded. While, in FIG. 2A and FIG. 2B, the end to be welded of the copper material 1 and the end to be welded of the steel material 2 are sleeve connected and then are welded. That is, the welding method provided by the invention is suitable for not only butt welding, but also sleeve welding.

### Embodiment 1

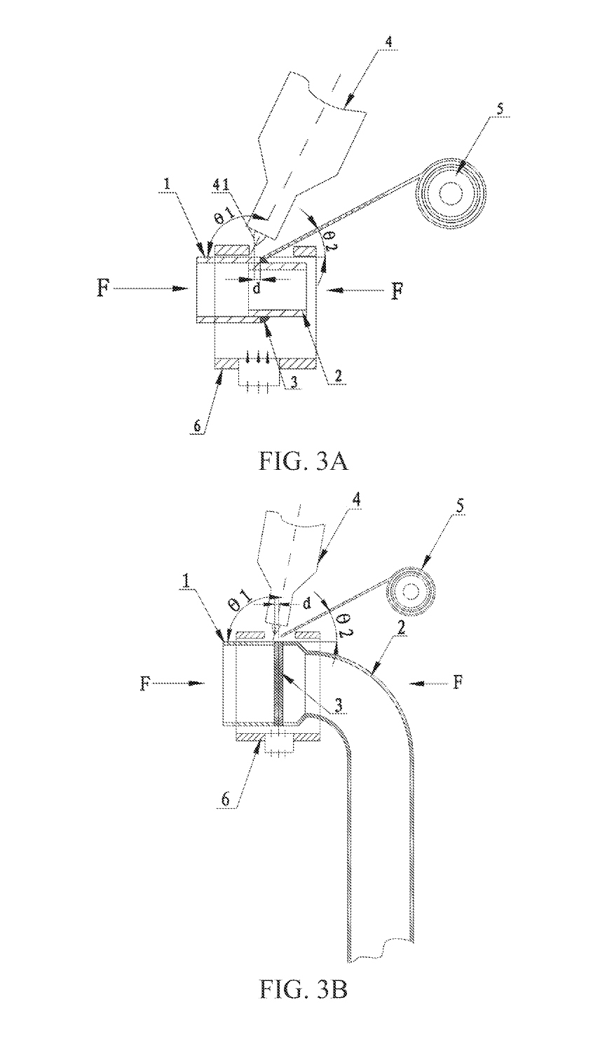

In this embodiment, a welding method for copper and steel is used for welding a gas inlet pipe and a gas outlet pipe of a liquid storage device for a compressor, as shown in FIG. 3A and FIG. 3B, respectively. The difference is that, in FIG. 3A, the end to be welded of a copper material 1 and the end to be welded of a steel material 2 are sleeve connected, the shift distance is a component of the distance from the top end of the heating part to an end surface of the end to be welded of the material which is arranged at the outside by sleeve connection in an axial direction of the copper material. In FIG. 3B, the end to be welded of a copper material 1 and the end to be welded of a steel material 2 are butt connected, and the shift distance is the component of the distance from the top end of the heating part to the butt connecting surface in the axial direction of the copper material. The embodiment will be described in detail below by taking the production principle diagram in FIG. 3A as an example.

In FIG. 3A, the end to be welded of the steel material 2 is sleeve connected to the inner of the end to be welded of the copper material 1 to form a welding workpiece. The shift distance d is the component of the distance from the top end of the heating part 41 to the end surface at the end to be welded of the copper material 1 in the axial direction of the copper material 1. The heating part 41 of a heat supply device 4 is used for heating the welding workpiece under the protection of a shielding gas. In the embodiment, the shielding gas is an inert gas. However, the invention is not limited thereto.

TABLE 1
Test data table at different shift distances of a welding gun to Cu side
Test conditions: under the same welding environment, except the different distances of the welding gun to the Cu
side, other parameters are the same.

| | | | | | | | | | Repeated |
|---|---|---|---|---|---|---|---|---|---|
| | | | Mutual | Grain | | Flexural | Torsional | Tensile | pressure |
| Test data | | Appearance | fusion zone | size | Gas hole | strength | strength | strength | resistance |
| The | 0.08 mm | Plump | No mutual | 0.09 mm | No gas | Positive | Fracture | Fracture | No |
| distance | | welding | fusion | | holes | and | exists on | exists | leakage |
| to the | | bead | partially | | | negative | Cu side | on Cu | |
| Cu side | | | | | | 180 | | side | |
| is less | | | | | | degrees: no | | | |
| than | | | | | | cracks | | | |
| 0.1 mm | 0.05 mm | Welding | No mutual | 0.07 mm | No gas | Positive | Fracture | Fracture | Leakage |
| | | bead with | fusion | | holes | and | exists on | exists | |
| | | partial | | | | negative | welding | on | |
| | | broken | | | | 180 | bead | welding | |
| | | line | | | | degrees: | | bead | |
| | | | | | | with cracks | | | |
| | 0 mm | Welding | No mutual | 0.05 mm | Penetrated | Positive | Fracture | Fracture | Leakage |
| | | bead with | fusion | | gas holes | and | exists on | exists | |
| | | broken | | | | negative | welding | on | |
| | | line | | | | 180 | bead | welding | |
| | | | | | | degrees: | | bead | |
| | | | | | | with cracks | | | |
| The | 0.1 mm | Smooth | Boundless | 0.08 mm | No gas | Positive | Fracture | Fracture | No |
| distance | | and plump | mutual | | holes | and | exists on | exists | leakage |
| to the | | welding | fusion | | | negative | Cu side | on Cu | |
| Cu side | | bead | | | | 180 | | side | |
| is | | | | | | degrees: no | | | |
| 0.1 mm-1.5 mm | | | | | | cracks | | | |
| | 0.15 mm | Smooth | Boundless | 0.07 mm | No gas | Positive | Fracture | Fracture | No |
| | | and plump | mutual | | holes | and | exists on | exists | leakage |
| | | welding | fusion | | | negative | Cu side | on Cu | |
| | | bead | | | | 180 | | side | |
| | | | | | | degrees: no | | | |
| | | | | | | cracks | | | |
| | 0.2 mm | Smooth | Boundless | 0.04 mm | No gas | Positive | Fracture | Fracture | No |
| | | and plump | mutual | | holes | and | exists on | exists | leakage |
| | | welding | fusion | | | negative | Cu side | on Cu | |
| | | bead | | | | 180 | | side | |
| | | | | | | degrees: no | | | |
| | | | | | | cracks | | | |
| | 0.5 mm | Smooth | Boundless | 0.06 mm | No gas | Positive | Fracture | Fracture | No |
| | | and plump | mutual | | holes | and | exists on | exists | leakage |
| | | welding | fusion | | | negative | Cu side | on Cu | |
| | | bead | | | | 180 | | side | |
| | | | | | | degrees: no | | | |
| | | | | | | cracks | | | |
| | 1.0 mm | Smooth | Boundless | 0.08 mm | No gas | Positive | Fracture | Fracture | No |
| | | and plump | mutual | | holes | and | exists on | exists | leakage |
| | | welding | fusion | | | negative | Cu side | on Cu | |
| | | bead | | | | 180 | | side | |
| | | | | | | degrees: no | | | |
| | | | | | | cracks | | | |
| | 1.5 mm | Smooth | Boundless | 0.09 mm | No gas | Positive | Fracture | Fracture | No |
| | | and plump | mutual | | holes | and | exists on | exists | leakage |
| | | welding | fusion | | | negative | Cu side | on Cu | |
| | | bead | | | | 180 | | side | |
| | | | | | | degrees: no | | | |
| | | | | | | cracks | | | |
| The | 1.8 mm | Welding | No mutual | 0.12 mm | No gas | Positive | Fracture | Fracture | Leakage |
| distance | | bead with | fusion | | holes | and | exists on | exists | |
| to the | | partial | partially | | | negative | welding | on | |
| Cu side | | broken | | | | 180 | bead | welding | |
| is more | | line | | | | degrees: | | bead | |
| than | | | | | | with cracks | | | |
| 1.5 mm. | 2.0 mm | Welding | No mutual | 0.15 mm | No gas | Positive | Fracture | Fracture | Leakage |
| | | bead with | fusion | | holes | and | exists on | exists | |
| | | broken | | | | negative | welding | on | |
| | | line | | | | 180 | bead | welding | |
| | | | | | | degrees: | | bead | |
| | | | | | | with cracks | | | |

As the heat conduction rate of the copper material 1 is about 6 times that of the steel material 2, in order to realize simultaneous melting of the end to be welded of the copper material 1 and the end to be welded of the steel material 2, the top end of the heating part 41 is shifted to the direction where the copper material 1 is, and the shift distance d is 0.1 mm-1.5 mm (including 0.1 mm and 1.5 mm). After the end to be welded of the copper material 1 and the end to be welded of the steel material 2 are simultaneously molten and further fuse mutually to form a liquid molten pool, a welding material 5 approaches the liquid molten pool, then the welding material 5 is molten by the liquid molten pool and a weld seam 3 is formed. However, whether to add the welding material or not is not limited in the invention. By adding the welding material 5, the connection strength of the weld seam can be further improved. In other embodiments, when welding, the welding material 5 may not be added, and after the liquid molten pool is cooled, the weld seam 3 is formed.

In this embodiment, the shift distance d can be 0.2 mm-0.3 mm. Table 1 shows a test data table of weld seams under different shift distances d. It can be known from Table 1 that, when the shift distance d is 0.2 mm, the diameter of grains formed after welding is minimal (that is the grain size scale is relatively high), which is only 0.04 mm. The weld seam 3 formed after welding is smooth and plump. Furthermore, as the welded end of the copper material 1 and the welded end of the steel material 2 are simultaneously molten and then fuse mutually, the formed mutual fusion zone is boundless. After welding, the weld seam 3 has no cracks after positive and negative 180 degrees flexure testing. After torsional strength testing, tensile strength and other types of destructive testing, it is found that a fracture exists on the side of the copper material 1 and has no influence on the weld seam 3. After repeated pressure testing, the weld seam 3 has no leakage and has great welding effect. However, of the value of the shift distance d is not limited in the invention. In other embodiments, a user can select other values within 0.1 mm-1.5 mm as the shift distance d according to actual welding requirements.

In addition, in order to further improve the quality of the weld seam 3 after welding, in the welding process, opposite action forces F are simultaneously applied to the ends of the copper material 1 and the steel material 2 far away from the welded position to improve the joint force for sleeve connect or butt connect.

In the embodiment, in order to better achieve simultaneous melting of the end to be welded of the copper material 1 and the end to be welded of the steel material 2 and facilitate welding, when in welding, the heating part 41 points at a welding spot, and an included angle θ1 between a central axis of the heating part 41 and a tangent plane where the welding spot is located is 5 degrees-175 degrees. Preferably, the included angle θ1 is set to be 5 degrees-30 degrees. However, the invention is not limited thereto.

In the embodiment, gas tungsten arc welding is adopted for welding the gas inlet pipe of the liquid storage device for the compressor, the heat supply device 4 is a welding gun, and the heating part 41 is a tungsten needle. However, the invention is not limited thereto. In other embodiments, any of argon arc welding, plasma welding, quasi-plasma welding, and laser welding can be adopted for welding the end to be welded of the copper material and the end to be welded of the steel material.

The specific welding process is as follows: under heating of external current, the tungsten needle performs arc striking to heat the welding spot on the welding workpiece, and after a certain time of heating (the process time is 0.1 s-8 s according to the thickness of a product), the end to be welded of the copper material 1 and the end to be welded of the steel material 2 are simultaneously molten to form the liquid molten pool. An external wire feeding mechanism (such as a wire feeding nozzle) is used for conveying the welding material 5 to the vicinity of the liquid molten pool, the heat of the liquid molten pool is used for melting the welding material 5, and then the weld seam 3 is further formed.

When the tungsten needle is used for heating the end to be welded of the copper material 1 and the end to be welded of the steel material 2, the heat will be inevitably diffused all around. In the embodiment, when the ends to be welded of the copper and steel materials are heated and molten by the heating part 41, the welding material 5 is preheated at a distance of 0.5 mm-50 mm from the welded spot. After the liquid molten pool is formed, the welding material 5 after being preheated gradually approaches the liquid molten pool, is molten by the liquid molten pool and then drops into the liquid molten pool so as to be molten with the liquid molten pool into a whole, thereby forming the weld seam 3 with the surface which is a raised non-linear circular arc curved surface with great tension. Due to relatively high temperature after being preheated, the welding material 5 can achieve a melting point very fast after approaching the liquid molten pool, therefore the melting time of the welding material 5 is greatly reduced, and the welding rate is further improved.

When in welding, if the top end of the heating part 41 is too high relative to the surface of the welding workpiece, the heat diffusion is serious, the heat led to the welding spot is reduced and the welding time is prolonged. However, if the top end of the heating part 41 is too low relative to the surface of the welding workpiece, the arc pressing phenomenon will appear. Thus, in the embodiment, the distance from the top end of the heating part 41 to the highest point of the welding workpiece is set to be 0.3 mm-2.5 mm. In the embodiment, as the steel material 2 is sleeved inside the copper material 1, the highest point of the welding workpiece is the highest point of the end to be welded of the copper material 1. In other embodiments, if the end to be welded of the copper material 1 is sleeved inside the end to be welded of the steel material 2, the highest point of the welding workpiece can be the highest point of the end to be welded of the steel material 2.

In the embodiment, in order to achieve smooth flow and joint of the welding material after melting and the liquid molten pool and further improve the welding rate, the included angle θ2 between the central line of the welding material 5 and the tangent plane where the welding spot is located is 2 degrees-178 degrees. Preferably, the included angle θ2 is set to be 30 degrees-60 degrees. However, the invention is not limited thereto.

In the embodiment, when in welding, a gas shielding device 6 for providing a shielding gas is added at the welded position, thereby effectively isolating air or other gas, avoiding the production of welding gas holes and improving the quality of the weld seam after welding. In the embodiment, the shielding gas is an argon gas. However, the invention is not limited thereto. In other embodiments, the shielding gas can be a nitrogen gas, the combination of helium gas and the argon gas, or the combination of a hydrogen gas and the argon gas. In order to further improve the welding quality and prevent the welding workpiece from being oxidized in the welding process, when in welding, carbon dioxide or nitrogen gas or other anti-oxidation gas is introduced into the welding workpiece.

As the welding of the gas inlet pipe is girth welding, when in welding, the copper material 1 and the steel material 2 which are sleeve connected with each other are rotated, the welding is performed in the rotation process, the annular weld seam 3 is finally formed, and the direction as shown by an arc-shaped arrow in the figure is the rotation direction. However, the invention is not limited thereto. In other embodiments, the girth welding can be realized by rotating the heat supply device 4.

In the embodiment, the welding material 5 is an iron-based welding wire with the iron content above 20%. However, the invention is not limited thereto. In other embodiments, the welding material 5 may be any of a nickel-based welding wire with the nickel content above 5%, a copper-based welding wire with the copper content above 15%, and a silver-based welding wire with the silver content above 3%.

In the embodiment, the steel material 2 is carbon steel. However, the invention is not limited thereto. In other embodiments, the steel material 2 may be stainless steel.

By adopting the welding method for copper and steel in the embodiment, when the two dissimilar metals, namely copper and steel, are butt welded or sleeve welded, by arranging the position of the heating part, the heat distributed to the end to be welded of the copper material 1 and the heat distributed to the end to be welded of the steel material 2 are equivalent, so that the synchronous melting of the two metals is realized and the weld seam 3 with small diameter of grains and high bending strength is formed. In the welding process, the liquid molten pool is used for melting the welding material 5. The welding material 5 cannot spatter during melting, the interference on arc voltage cannot be produced, and the problems of insufficient mutual fusion and the like cannot appear during welding.

### Embodiment 2

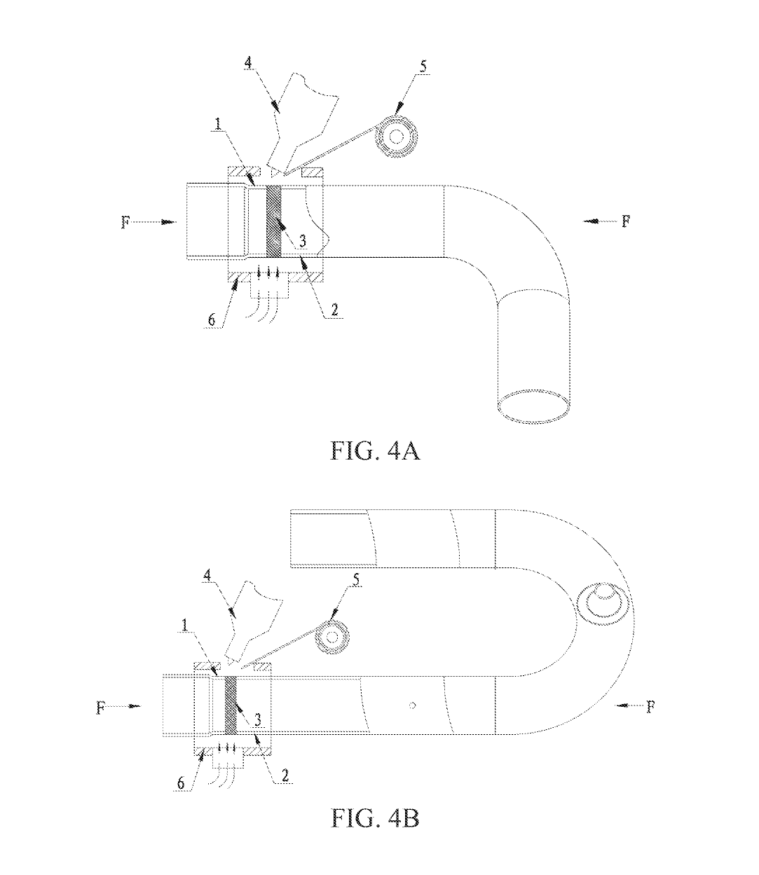

In the embodiment, a welding method for copper and steel is used for welding a gas inlet pipe and a gas outlet pipe of a gas-liquid separator for a central air conditioner, as shown in FIG. 4a and FIG. 4b. The embodiment is basically the same as embodiment 1 and the changes thereof, and the differences are as follows:

In FIG. 4a and FIG. 4b, the end to be welded of the copper material 1 and the end to be welded of the steel material 2 are butt welded, and the shift distance d is a component of the distance from the top end of the heating part 41 to the butt connecting surface in the axial direction of the copper material 1. The top end of the heating part 41 is shifted towards the copper material 1, and the shift distance d is 0.1 mm. It can be seen from Table 1 that when the shift distance d is 0.1 mm, the diameter of the grains formed after welding is only 0.08 mm, and the testing shows that various indexes of the weld seam 3 can meet the requirements. However, the invention is not limited thereto. In other embodiments, the user can select other values within 0.1 mm-1.5 mm as the shift distance d according to actual welding requirements.

In the embodiment, in order to better achieve simultaneous melting of the end to be welded of the copper material 1 and the end to be welded of the steel material 2, the included angle θ1 between the central axis of the heating part 41 and a tangent plane where the welding spot is located is 5 degrees-175 degrees. Preferably, the included angle θ1 is set to be 30 degrees-60 degrees. However, the invention is not limited thereto.

In the embodiment, in order to achieve smooth flow and joint of the welding material after melting and the liquid molten pool and further improve the welding rate, the included angle θ2 between the central line of the welding material 5 and the tangent plane where the welding spot is located is 60 degrees-90 degrees. However, the invention is not limited thereto.

### Embodiment 3

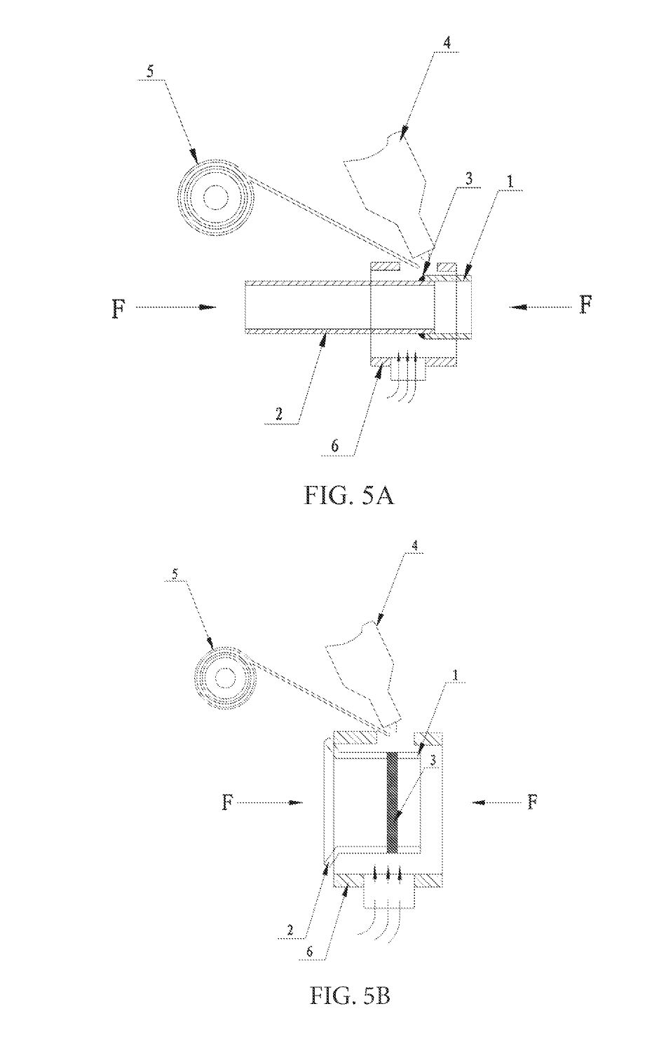

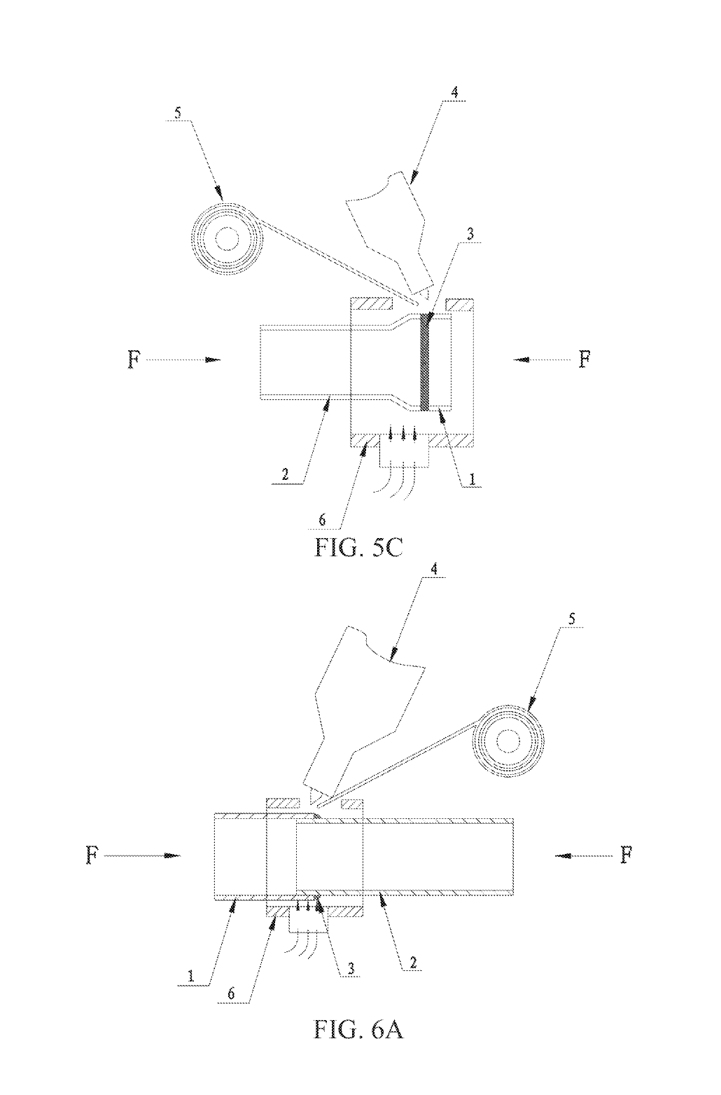

In the embodiment, a welding method for copper and steel is used for welding an exhaust pipe, a gas suction outer pipe and a gas suction inner pipe of a refrigeration compressor, as shown in FIG. 5a, FIG. 5b and FIG. 5c. The embodiment is basically the same as embodiment 1 and the changes thereof, and the differences are as follows.

In FIG. 5a, the end to be welded of the steel material 2 is sleeve connected inside the end to be welded of the copper material 1, and the shift distance d is a component of the distance from the top end of the heating part to the end surface at the end to be welded of the copper material 1 in the axial direction of the copper material 1. In FIG. 5b and FIG. 5c, the end to be welded of the copper material 1 and the end to be welded of the steel material 2 are butt welded, and the shift distance d is the component of the distance from the top end of the heating part to the butt connecting surface in the axial direction of the copper material. In FIG. 5a, FIG. 5b, and FIG. 5c, except the different connection ways, other welding conditions are the same, and the specific implementation is as follows.

The top end of the heating part is shifted towards the copper material 1, and the shift distance d is 0.5 mm. It can be seen from Table 1 that when the shift distance d is 0.5 mm, the diameter of the grains formed after welding is only 0.06 mm, and the testing results show that various indexes of the weld seam 3 can meet the requirements. However, the invention is not limited thereto. In other embodiments, the user can select other values within 0.1 mm-1.5 mm as the shift distance d according to actual welding requirements.

In the embodiment, in order to better achieve simultaneous melting of the end to be welded of the copper material 1 and the end to be welded of the steel material 2, the included angle θ1 between the central axis of the heating part 41 and the tangent plane where the welding spot is located is 5 degrees-175 degrees. Preferably, the included angle θ1 is set to be 60 degrees-90 degrees. However, the invention is not limited thereto.

In the embodiment, in order to achieve smooth flow and joint, the welding material after melting and the liquid molten pool and further improve the welding rate, the included angle θ2 between the central line of the welding material 5 and the tangent plane where the welding spot is located is 90 degrees-135 degrees. However, the invention is not limited thereto.

### Embodiment 4

In the embodiment, a welding method for copper and steel is used for welding a C pipe (S pipe or E pipe) and a D pipe in an electromagnetic four-way reversing valve for an air conditioner. The embodiment is basically the same as embodiment 1 and the changes thereof, and the differences are as follows.

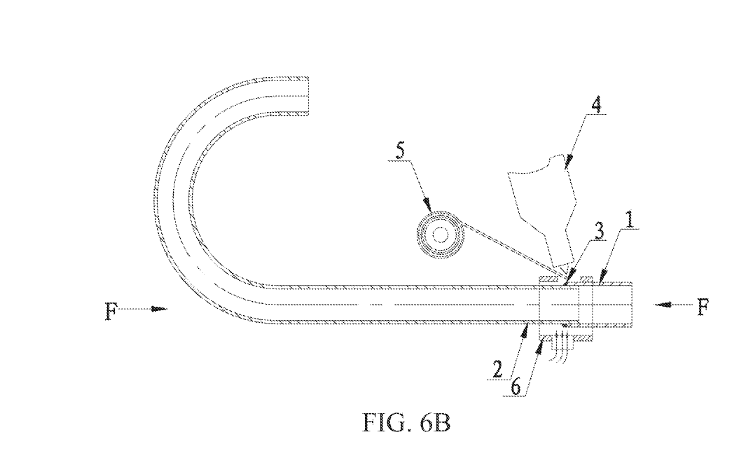

As shown in FIGS. 6A and 6B, the end to be welded of the steel material 2 is sleeve connected inside the end to be welded of the copper material 1, and the shift distance d is a component of the distance from the top end of the heating part 41 to the end surface at the end to be welded of the copper material 1 in the axial direction of the copper material 1. The top end of the heating part 41 is shifted towards the copper material 1, and the shift distance d is 1.5 mm. It can be seen from Table 1 that when the shift distance d is 1.5 mm, the diameter of grains formed after welding is only 0.09 mm, and the testing results show that various indexes of the weld seam 3 can meet the requirements. However, the invention is not limited thereto. In other embodiments, the user can select other values within 0.1 mm-1.5 mm as the shift distance d according to actual welding requirements.

In the embodiment, in order to better achieve simultaneous melting of the end to be welded of the copper material 1 and the end to be welded of the steel material 2, the included angle θ1 between the central axis of the heating part 41 and the tangent plane where the welding spot is located is 5 degrees-175 degrees. Preferably, the included angle θ1 is set to be 90 degrees-135 degrees. However, the invention is not limited thereto.

### Embodiment 5

In the embodiment, a welding method for copper and steel is used for welding a piping of a stop valve. The embodiment is basically the same as embodiment 1 and the changes thereof, and the differences are as follows.

The end to be welded of the copper material 1 at the upper part of the piping of the stop valve and the end to be welded of the steel material 2 are butt connected, and the end to be welded of the steel material 2 is arranged inside the end to be welded of the copper material 1 by sleeve connection at the lower part of the piping of the stop valve. Except the different connection ways, other conditions are the same. The specific implementation is as follows.

The top end of the heating part 41 is shifted towards the copper material 1, and the shift distance d is 0.15 mm. It can be seen from Table 1 that when the shift distance d is 0.15 mm, the diameter of grains formed after welding is only 0.07 mm, and the testing results show that various indexes of the weld seam 3 can meet the requirements. However, the invention is not limited thereto. In other embodiments, the user can select other values within 0.1 mm-1.5 mm as the shift distance d according to actual welding requirements.

In the embodiment, in order to better achieve simultaneous melting of the end to be welded of the copper material 1 and the end to be welded of the steel material 2, the included angle θ1 between the central axis of the heating part 41 and the tangent plane where the welding spot is located is 5 degrees-175 degrees. Preferably, the included angle θ1 is set to be 135 degrees-175 degrees. However, the invention is not limited thereto.

In conclusion, in the welding process, considering the situation that the heat conduction rate of the copper material 1 is much higher than that of the steel material 2, that is the heat dissipation of the copper material 1 is faster than that of the steel material 2, by setting the position of the heating part 41 for providing heat for welding, the top end of the heating part 41 is shifted to the direction where the copper material 1 is. Thus, the heat distributed to the end to be welded of the copper material 1 is more than the heat distributed to the end to be welded of the steel material 2, and the two materials achieve a synchronous melting state and further fuse mutually boundlessly to form the weld seam without leakages or cracks.

In addition, the liquid molten pool is used for melting the welding material 5 and then forming the weld seam 3, thereby avoiding the problem of incomplete fusion of the welding wire caused by unstable arc voltage due to the existence of the welding material in the arc striking process of the tungsten needle. Meanwhile, the liquid molten pool is used for melting the welding material, so that no spattering exists in the welding process, a workpiece after welding does not need to be cleared up, the welding penetration depth after welding meets the requirements, and the weld seam is plump and has relatively large surface tension. In order to avoid the production of gas holes in the weld seam in the welding process, the heating part is protected by the shielding gas and a gas shielding device is further added at a welded position, thereby effectively isolating air or other gas and avoiding the production of the welding gas holes. Further, the welding method for copper and steel provided by the invention can realize all-position welding, and the excellent welding effect can be obtained even in the situations of vertical-down welding, vertical-up welding and overhead welding.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A welding method for copper and steel, comprising the following steps:
butt connecting or sleeve connecting an end to be welded of a copper material with an end to be welded of a steel material; and
welding and connecting the end to be welded of the copper material and the end to be welded of the steel material by a heating part of a heat supply device under the protection of a shielding gas, wherein a top end of the heating part is shifted towards the copper material, and the end to be welded of the copper material and the end to be welded of the steel material are simultaneously molten and further fuse mutually.

2. The welding method for copper and steel according to claim 1, wherein the top end of the heating part is shifted towards the copper material, a shift distance is 0.1 mm-1.5 mm, when the end to be welded of the copper material and the end to be welded of the steel material are butt connected to form a butt connecting surface, the shift distance is the distance from the top end of the heating part to the butt connecting surface, and when the end to be welded of the copper material and the end to be welded of the steel material are sleeve connected, the shift distance is the distance from the top end of the heating part to an end surface of the end to be welded of the material arranged at the outside by sleeve connection.

3. The welding method for copper and steel according to claim 2, wherein the top end of the heating part is shifted towards the copper material, and the shift distance is 0.2 mm-0.3 mm.

4. The welding method for copper and steel according to claim 1 or 2, wherein the end to be welded of the copper material and the end to be welded of the steel material are welded and connected by the heating part of the heat supply device under the protection of an inert gas, and the end to be welded of the copper material and the end to be welded of the steel material are simultaneously molten and further fuse mutually to form a weld seam.

5. The welding method for copper and steel according to claim 1 or 2, wherein the heating part of the power supply device points at a welding spot, and an included angle between a central axis of the heating part and a tangent plane where the welding spot is located is 5 degrees-175 degrees.

6. The welding method for copper and steel according to claim 1, wherein in the welding process, a gas shielding device for providing a shielding gas is disposed at the place where the copper material and the steel material are butt connected or sleeve connected.

7. The welding method for copper and steel according to claim 1 or 2, wherein a welding material is added during welding and connecting of the end to be welded of the copper material and the end to be welded of the steel material, the end to be welded of the copper material and the end to be welded of the steel material are simultaneously molten and further fuse mutually to form a liquid molten pool, and the welding material is molten in the liquid molten pool to form a weld seam.

8. The welding method for copper and steel according to claim 7, wherein the welding material is selected from the group consisting of an iron-based welding wire, a nickel-based welding wire, a copper-based welding wire, and a silver-based welding wire.

9. The welding method for copper and steel according to claim 7, wherein before the formation of the liquid molten pool, the welding material is preheated at a distance of 0.5 mm-50 mm from a welding spot, and after the formation of the liquid molten pool, the welding material after being preheated gradually approaches the liquid molten pool and is molten by the liquid molten pool.

10. The welding method for copper and steel according to claim 1, wherein the end to be welded of the copper material is welded and connected with the end to be welded of the steel material by the welding technique selected from the group consisting of gas tungsten arc welding, argon arc welding, plasma welding, quasi-plasma welding, and laser welding.

11. The welding method for copper and steel according to claim 1, wherein the steel material is carbon steel or stainless steel.

12. Application of the welding method for copper and steel according to any one of claims 1-11, wherein the welding method for copper and steel is applied to welding of a housing of a liquid storage device for a compressor, a housing of a silencer for an air conditioner, a housing of a gas-liquid separator for a central air conditioner, a housing of an oil-gas separator, an exhaust pipe for a refrigeration compressor, a gas suction inner pipe for the refrigeration compressor, a gas suction outer pipe for the refrigeration compressor, a gas inlet pipe of the liquid storage device, a gas outlet pipe of the liquid storage device, a main valve body and a main valve seat of an electromagnetic four-way reversing valve for the air conditioner, a piping on the electromagnetic four-way reversing valve for the air conditioner, a piping of the air conditioner, a connecting pipe of the air conditioner, a reversing valve pipe of the air conditioner, or an expansion valve pipe of the air conditioner.
